(19) United States
(12) Patent Application Publication
(10) Pub. No.: US 2016/0196618 A1
(43) Pub. Date: Jul. 7, 2016

(54) SYSTEM AND METHOD FOR AUTOMATICALLY GENERATING RECLAIM DATA RESPECTIVE OF PURCHASES

(71) Applicant: Vatbox, Ltd., Herzliya (IL)

(72) Inventors: Isaac SAFT, Kfar Neter (IL); Noam GUZMAN, Ramat Hasharon (IL)

(73) Assignee: Vatbox, Ltd., Herzliya (IL)

(21) Appl. No.: 14/989,529

(22) Filed: Jan. 6, 2016

Related U.S. Application Data
(60) Provisional application No. 62/100,574, filed on Jan. 7, 2015.

(51) Int. Cl. G06Q 40/00

(52) U.S. Cl. CPC G06Q 40/123

(57) ABSTRACT

A system and method for automatically generating reclaim data respective of purchases are provided. The method includes receiving a request indicating at least a data source including a plurality of purchase files; determining a reclaim document type of each purchase file; respective of the determined reclaim document types, retrieving at least one index element, wherein each index element indicates a reclaim requirement; analyzing the purchase files to identify at least one qualification element respective of the at least one index element; comparing the at least one qualification element to the at least one index element to identify at least one qualified purchase file; and generating qualified reclaim data including the at least one qualified purchase file.

### CROSS-REFERENCE TO RELATED APPLICATIONS

This application claims the benefit of U.S. Provisional Application No. 62/100,574 filed on Jan. 7, 2015, the contents of which are hereby incorporated by reference.

### TECHNICAL FIELD

The present disclosure relates generally to purchase reclaim data systems, and more specifically to automatically generating reclaim data respective of purchases.

### BACKGROUND

The Value-Added Tax (VAT) is a broadly based consumption tax assessed on the value added to goods and services. A particular VAT applies to most goods and services that are bought or sold within a given community. When a person travels abroad and makes a purchase that requires paying a VAT, that person may be entitled to a subsequent refund of the VAT for the purchase. Other taxes applied to purchases may similarly be refunded under particular circumstances. Further, sellers may offer rebates for purchases of products sold in certain locations and under particular circumstances. Such refunds of the purchase price may be reclaimed by following procedures established by the refunding entity.

The laws and regulations of many countries allow foreign travelers the right for reimbursement or a refund of certain taxes such as, e.g., VATs paid for goods and/or services abroad. As such laws and regulations are different from one country to another, determination of the actual VAT refunds that one is entitled to receive often requires that the seeker of the refund possess a vast amount of knowledge in the area of tax laws abroad. Moreover, travelers may seek refunds for VATs when they are not entitled to such refunds, thereby spending time and effort on a fruitless endeavor. Further, availability of the VAT refund may vary based on the type of purchase made and the presence of a qualified VAT receipt.

One procedure to request a refund is to physically approach a customs official at an airport, fill out a form, and file the original receipts respective of the expenses incurred during the visit. This procedure should be performed prior to checking in or boarding to the next destination. Additionally, particularly with respect to goods purchased abroad, the procedure to request a refund may require that the payer show the unused goods to a custom official to verify that the goods being exported match the goods that the payer paid VATs on.

As travelers are not familiar with specific laws and regulations for claiming a refund, the travelers may submit a claim for a refund even though they are not eligible. This procedure further unnecessarily wastes time if the traveler ultimately learns that he or she is not entitled to a refund. It would therefore be advantageous to provide a solution that would overcome the deficiencies of the prior art by providing an effective way to handle VAT refunds electronically and, preferably, over the Internet.

The challenges facing customers seeking a refund and, in particular, seeking VAT refunds, may result in customers becoming discouraged and failing to follow through on obtaining their refunds. This issue is further compounded when the customer is an employee of an enterprise because the customer is not directly benefiting from the refund. Moreover, employees may submit irrelevant or duplicate information that is unnecessary for seeking refunds. Filtering through such unnecessary information may be time-consuming, costly, and subject to a large degree of human error.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some of the disclosed embodiments include a method for automatically generating reclaim data respective of purchases. The method comprises receiving a request indicating at least a data source including a plurality of purchase files; determining a reclaim document type of each purchase file; respective of the determined reclaim document types, retrieving at least one index element, wherein each index element indicates a reclaim requirement; analyzing the purchase files to identify at least one qualification element respective of the at least one index element; comparing the at least one qualification element to the at least one index element to identify at least one qualified purchase file; and generating qualified reclaim data including the at least one qualified purchase file.

Some of the disclosed embodiments also include a system for automatically generating reclaim data respective of purchases. The system comprises a processing unit; and a memory, the memory containing instructions that, when executed by the processing unit, configure the system to: receive a request indicating at least a data source including a plurality of purchase files; determine a reclaim document type of each purchase file; respective of the determined reclaim document types, retrieve at least one index element, wherein each index element indicates a reclaim requirement; analyze the purchase files to identify at least one qualification element respective of the at least one index element; compare the at least one qualification element to the at least one index element to identify at least one qualified purchase file; and generate qualified reclaim data including the at least one qualified purchase file.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram used to describe the various disclosed embodiments.

FIG. 2 is a flowchart illustrating a method for generating qualified data respective of purchase data according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

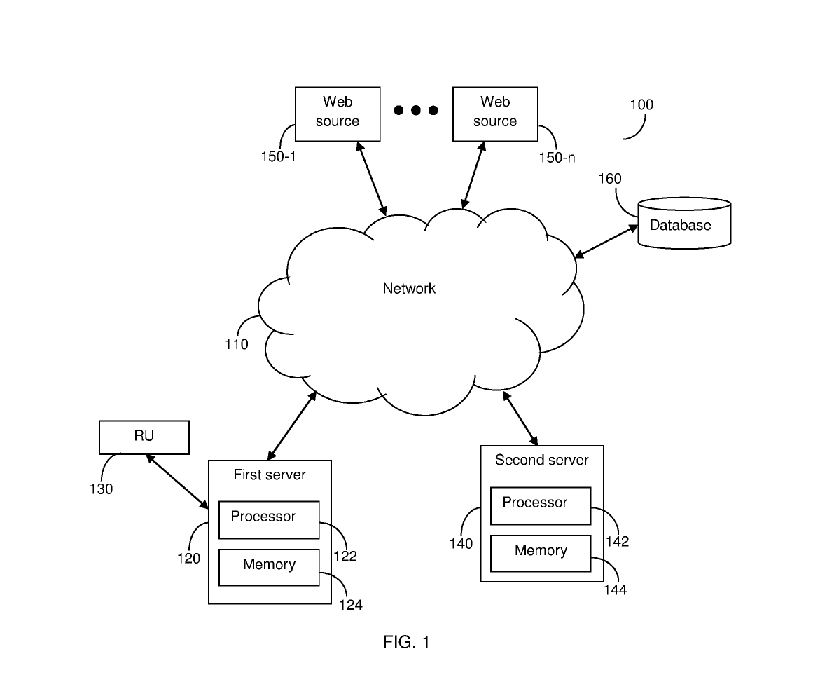

FIG. 1 shows an exemplary and non-limiting network diagram 100 utilized to describe the various disclosed embodiments. A network 110 is communicatively connected to a first server 120, a second server 140, a plurality of web sources 150 (hereinafter referred to individually as a web source 150 and collectively as web sources 150, merely for simplicity purposes), and a database 160. The network 110 may be, but is not limited to, a local area network (LAN), a wide area network (WAN), a metro area network (MAN), the worldwide web (WWW), the Internet, a wired network, a wireless network, similar networks and any combinations thereof.

The first server 120 may be communicatively connected to a recognition unit (RU) 130. The recognition unit 130 is configured to perform machine analysis techniques respective of purchase files. The recognition unit 130 may include, but is not limited to, an optical character recognition unit, an image recognition unit, and a combination thereof. The first server 120 may be configured to receive purchase files associated with purchases captured by devices belonging to an entity (not shown) and to determine which of the purchase files are qualified.

The web sources 150 store regulatory data related to reclaims. As an example, one of the web sources 150 may store a European data sheet specifying requirements for inter-country value added tax (VAT) reclaims. The database 160 may store purchase data respective of enterprises. The purchase data may include a plurality of purchase files such as, but not limited to, a document, an invoice, an image, a travel expense sheet, combinations thereof, and so on. Each purchase file is associated with one or more purchases by a representative of an enterprise.

In an embodiment, the first server 120 may be configured to receive a request from the second server 140 to identify qualified data respective of the plurality of purchase files stored in the database 160. The second server 140 may be operated by an entity of an enterprise. Qualified data may refer to, for example, data for which a portion of the purchase price can be reclaimed. Data for which a portion of the purchase price cannot be reclaimed may be referred to as unqualified data. Unqualified data may include, for example, duplicated invoices, missing tax receipts, partially filled invoices, and so on.

Responsive to the received request, the first server 120 is configured to retrieve metadata respective of an enterprise associated with the second server 140. The metadata may include, but is not limited to, a location of establishment of the enterprise. The location of establishment may be a geographic location in which the enterprise is registered or otherwise exists such as, e.g., a country of incorporation, a country of formation, a country of operations, and so on.

The server 120 analyzes the purchase files using the recognition unit 130. Based on the analysis, the server 120 identifies a plurality of index elements required for determining whether the purchase files are qualified. A purchase file may be qualified if, e.g., the purchase file includes information respective of a purchase that qualifies for a reclaim. The index elements may be extracted from one or more of the web sources 150 respective of the metadata and/or the analysis of the purchase files. The index elements may differ for each type of purchase file. As an example, if a purchase file is an invoice, the index elements for the purchase file may be identified as the name of the merchant, an address of the merchant, a VAT exemption number of the merchant, and so on. If the purchase file is a tax-free form, the index elements for the purchase file may be identified as passport number, a name of the customer, and an address of the customer.

The server 120 analyzes the purchase files to determine whether each purchase file is qualified respective of the identified index elements. The analysis may include optical character recognition (OCR) of the purchase files to identify one or more qualification elements in each purchase file. The identified qualification elements may be compared to the index elements to determine whether a qualification element meeting the requirements of each index element is included in the purchase file.

Respective of the determination, the server 120 may be configured to generate qualified reclaim data. The qualified reclaim data may include information from the qualified purchase files. The qualified reclaim data may be utilized to generate a reclaim request and/or to provide further analysis of the purchase files. As an example, the qualified reclaim data may include purchase prices from each of the purchase files that may be utilized to generate an expense summary including total expenditures over a period of time.

The server 120 may be further configured to generate a visual representation of the qualification of each purchase file. The visual representation may include, but is not limited to, a travel report, an expense summary, and so on. The first server 120 may be configured to send the visual representation to the second server 140. The visual representation may be generated respective of one or more of the purchase files and may be, but is not limited to, a graphical representation. In an embodiment, the graphical representation may be generated respective of a financial sheet of the enterprise. In a further embodiment, the graphical representation may indicate a relation between the estimated travel expenses respective of the financial sheet of the enterprise and the actual travel expenses respective of the comparison.

It should be understood that the embodiments disclosed herein are not limited to the specific architecture illustrated in FIG. 1, and other architectures may be equally used without departing from the scope of the disclosed embodiments. Specifically, each of the servers 120 and 140 may reside in a cloud computing platform, a datacenter, and the like. Moreover, in an embodiment, there may be a plurality of servers operating as described hereinabove and configured to either have one as a standby, to share the load between them, or to split the functions between them.

It should be further noted that the recognition unit 130 may be integrated in the server 120 without departing from the disclosed embodiments.

The first server 120 typically includes a processing unit 122 coupled to a memory 124. The second server 140 typically includes a processing unit 142 coupled to a memory 144. Each of the processing units 122 and 142 may comprise or be a component of a processor (not shown) or an array of processors coupled to the memory 124 or 144, respectively. The memories 124 and 144 contain instructions that can be executed by the processing units 122 and 142, respectively. The instructions, when executed by the processing unit 122 or 142, cause the processing unit 122 or 142 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

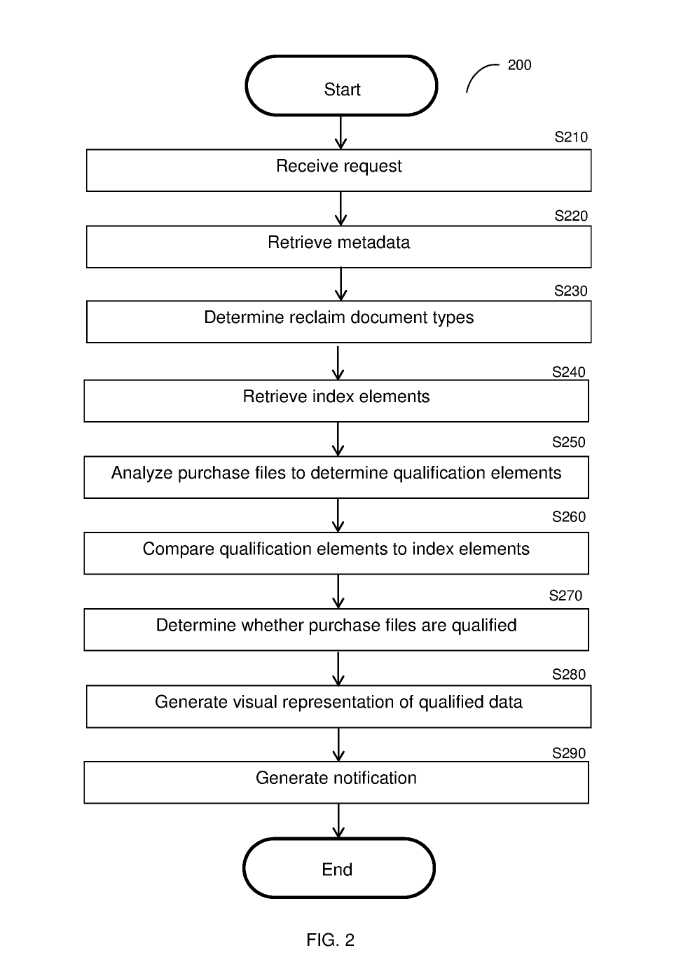

FIG. 2 is an exemplary and non-limiting flowchart 200 illustrating a method for generating qualified data respective of purchase data according to an embodiment. In an embodiment, the method may be performed by a server (e.g., the first server 120).

In S210, a request to identify qualified data in a data set including purchase files is received. In an embodiment, the request may indicate a source of the data set (e.g., a database belonging to an enterprise, a server operated by an enterprise, and so on) as well as a requesting entity (e.g., an enterprise). In a further embodiment, the request may also indicate a type of reclaim being sought (e.g., a reclaim of a VAT, of a refundable sales tax, of a rebate, and so on). The purchase files may include, but are not limited to, documents, invoices, images, travel expense sheets, and so on.

In optional S220, metadata may be retrieved respective of the request. The metadata may indicate, e.g., a location of origin of the requesting entity. Such origin metadata may be utilized when, for example, the request is for value added tax (VAT) reclaims, where the country of origin is relevant to VAT reclaim eligibility. In an embodiment, the metadata may be extracted from a database of the requesting entity (e.g., the database 160).

In S230, the purchase files are analyzed to determine a reclaim document type of each purchase file. Reclaim document types may include, but are not limited to, invoices, tax-free forms, rebate coupons, and so on. The analysis may include, but is not limited to, textual analysis of a file name of each purchase file, optical character recognition of content in each purchase file, analysis of user inputs respective of each purchase file, and so on. As an example, identification of the word “invoice” in the file name, in the purchase file, or in a user description of the purchase file may result in determining that the reclaim document type is an invoice.

In S240, one or more index elements for determining whether the purchase files of the data set are qualified are retrieved. In an embodiment, the index elements may be retrieved respective of the determine reclaim document types. For example, index elements of an invoice may include merchant identifiers (e.g., name, address, VAT status), purchase identifiers (e.g., price, type of product, description of product), and so on. As another example, index elements of a rebate coupon may include product identifiers (name, serial number, and so on). In a further embodiment, the index elements may be retrieved respective of the type of reclaim being sought. The index elements may be extracted from web sources.

The index elements may indicate requirements of the reclaim and may include, but are not limited to required information (e.g., a price value, a name, an address, a serial number, and so on), diversity requirements (e.g., that a country of establishment of the enterprise is different from the country in which the purchases were made), purchase requirements (e.g., minimum price thresholds, specific categories of products, particular products as identified by name or serial number, etc.), and so on.

In S250, the purchase files are analyzed to identify qualification elements respective of the index elements. In an embodiment, S240 may include retrieving the purchase files respective of the requesting entity. The analysis may include, but is not limited to, visual or character recognition of the purchase files. The reclaim document types may include, but are not limited to, invoice, tax-free form, rebate coupon, and so on. The qualification elements may be identified based on the types of information as required by the index elements. As an example, if an index element for a purchase file is a price value, an identified qualification element may be “49 [symbol] .”

In S260, the identified qualification elements may be compared to the index elements to determine whether each purchase file is qualified. A purchase file may be qualified if it includes qualification elements respective of all index elements for the purchase file. As an example, an invoice may have index elements of merchant name, merchant address, product name, and product price. The invoice may be qualified if it contains the following qualification elements: “Small Store Antiques,” “123 Antiquing Lane, England,” “handcrafted wooden chair,” and “300 [symbol] .”

In S270, qualified reclaim data generated respective of the comparison. The qualified reclaim data may include, but is not limited to, verified purchase files, total purchase price among the purchase files, total numbers of purchases reflected in the purchase files, and so on. The qualified reclaim data may be further utilized to generate reclaims and/or to perform analysis of the purchase files. For example, information in the qualified set may be utilized in part to fill out a reclaim request form. As another example, purchase prices in the qualified data set may be added to determine total expenses for a given period of time.

In S280, a visual representation of the qualified data is generated. The visual representation may be, but is not limited to, a graphical representation. The qualified data may include data from each qualified purchase file. The visual representation may illustrate, e.g., travel information (i.e., a travel report indicating locations at which employees purchased products), expense summaries (e.g., travel expenses for a period of time), and so on.

In optional S290, a notification may be generated and sent respective of the qualification of the purchase files. The notification may indicate, for any or all of the purchase files, qualified data and/or that no qualified purchase file was found.

As a non-limiting example, a request for identifying qualified data for VAT reclaims is received. The request indicates an enterprise and a database used by the enterprise. The database includes purchase files scanned by employees of the enterprise while traveling abroad. Metadata indicating that the enterprise's country of origin is France is retrieved. Based on an analysis of the purchase files, it is determined that the purchase files include invoices. The index elements for the invoices include a VAT identification number, a country that is not France, purchase price, and a product category that is not food. Respective of the index elements, the following qualification elements are identified: “FR00123456789,” “Germany,” “100 [symbol] ,” and “jewelry.” The identified qualification elements are compared to the index elements to determine if each index element is met for each purchase file, and a qualified data set is generated based on the purchase file containing the identified qualification elements. A visual representation of the qualified data set featuring an expense report for the visit to Germany may be generated. Further, a notification regarding the qualified invoice purchase file is generated and sent to a system of the enterprise.

It should be noted that the embodiments described herein above are discussed primarily with respect to VAT reclaims merely for simplicity purposes and without limitations on the disclosure. The disclosed embodiments may be utilized to generate qualified data sets respective of other types of reclaims.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automatically generating reclaim data respective of purchases, comprising:
receiving a request indicating at least a data source including a plurality of purchase files;
determining a reclaim document type of each purchase file;
respective of the determined reclaim document types, retrieving at least one index element, wherein each index element indicates a reclaim requirement;
analyzing the purchase files to identify at least one qualification element respective of the at least one index element;
comparing the at least one qualification element to the at least one index element to identify at least one qualified purchase file; and
generating qualified reclaim data including the at least one qualified purchase file.

2. The method of claim 1, wherein the request indicates a requesting entity, further comprising:
retrieving metadata respective of the requesting entity, wherein the identification of at least one qualified purchase file is further based on the metadata.

3. The method of claim 2, wherein the request is for value added tax (VAT) reclaims, wherein the metadata includes a location of establishment of the requesting entity.

4. The method of claim 1, wherein analyzing the purchase files includes optical character recognition of the at least one qualification element in the purchase files.

5. The method of claim 1, further comprising:
generating a visual representation of the qualified reclaim data.

6. The method of claim 5, wherein the visual representation is a graphical representation, wherein the graphical representation is generated respective of a financial sheet purchase file of the requesting entity.

7. The method of claim 1, wherein each reclaim document type is any of: an invoice, a tax-free form, and a rebate coupon.

8. The method of claim 1, wherein the request indicates a type of reclaim, wherein the at least one index element is retrieved further based on the type of reclaim.

9. The method of claim 1, wherein the qualified reclaim data set includes at least one of: a qualified purchase file, and a purchase price.

10. A non-transitory computer readable medium having stored thereon instructions for causing one or more processing units to execute the method according to claim 1.

11. A system for automatically generating reclaim data respective of purchases, comprising:
a processing unit; and
a memory, the memory containing instructions that, when executed by the processing unit, configure the system to:
receive a request indicating at least a data source including a plurality of purchase files;
determine a reclaim document type of each purchase file;
respective of the determined reclaim document types, retrieve at least one index element, wherein each index element indicates a reclaim requirement;
analyze the purchase files to identify at least one qualification element respective of the at least one index element;
compare the at least one qualification element to the at least one index element to identify at least one qualified purchase file; and
generate qualified reclaim data including the at least one qualified purchase file.

12. The system of claim 11, wherein the request indicates a requesting entity, wherein the system is further configured to:
retrieve metadata respective of the requesting entity, wherein the identification of at least one qualified purchase file is further based on the metadata.

13. The system of claim 12, wherein the request is for value added tax (VAT) reclaims, wherein the metadata includes a location of establishment of the requesting entity.

14. The system of claim 11, wherein analyzing the purchase files includes optical character recognition of the at least one qualification element in the purchase files.

15. The system of claim 11, wherein the system is further configured to:
generate a visual representation of the qualified reclaim data.

16. The system of claim 15, wherein the visual representation is a graphical representation, wherein the graphical representation is generated respective of a financial sheet purchase file of the requesting entity.

17. The system of claim 11, wherein each reclaim document type is any of: an invoice, a tax-free form, and a rebate coupon.

18. The system of claim 11, wherein the request indicates a type of reclaim, wherein the at least one index element is retrieved further based on the type of reclaim.

19. The system of claim 11, wherein the qualified reclaim data set includes at least one of: a qualified purchase file, and a purchase price.
